(19) United States
(12) Patent Application Publication
(10) Pub. No.: US 2018/0189909 A1
(43) Pub. Date: Jul. 5, 2018

(54) PATENTABILITY SEARCH AND ANALYSIS

(71) Applicant: AT&T INTELLECTUAL PROPERTY I, L.P., Atlanta, GA (US)

(72) Inventors: Samuel N. Zellner, Atlanta, GA (US); Scott Frank, Dunwoody, GA (US); Robert Moton, JR., Alpharetta, GA (US); Ari Craine, Marietta, GA (US); Jason V. Chang, Decatur, GA (US)

(21) Appl. No.: 15/808,236

(22) Filed: Nov. 9, 2017

Related U.S. Application Data
(60) Provisional application No. 62/441,102, filed on Dec. 30, 2016.

(51) Int. Cl. G06Q 50/18; G06F 17/30

(52) U.S. Cl. CPC G06Q 50/184; G06F 17/30477; G06F 17/30864; G06F 17/30011

(57) ABSTRACT

A patentability search and analysis system can, based on a submission, perform a patentability search that finds prior art relevant to the submission. An example system can operate to indicate the relevancy of prior art documents discovered in the search, and categorize the art. The system can determine a patentability indicator (e.g., a patentability score) representative of the likelihood that a patent will be granted on a patent application representative of the submission. The system can, based on an analysis of filed patent applications, provide rejection and allowance rates for the claims of those applications having a similar patentability indicator value to that of the patentability indicator. The rejection and allowance rates can be for the patent office as a whole, the art unit, or the examiner. Additionally, the system can provide a “confidence level” representative of the strength of the patentability indicator.

### RELATED APPLICATION

The present application claims priority to U.S. Provisional Application No. 62/441,102, filed on Dec. 30, 2016, and titled, “Systems and Methods for Processing Patent Applications Using Pre-filing and Post-Filing Electronic Searches,” the entirety of which application is hereby incorporated by reference herein.

### TECHNICAL FIELD

The present application relates generally to the field of data processing and, for example, to systems and methods for performing patentability searching and analysis.

### BACKGROUND

Innovation is the engine that drives the formation and growth of companies. To leverage innovation, individuals and companies can invest both time and money in an attempt to transform a concept into a product or service. Patents play a critical role in enabling individuals and companies to make these investments directly, or to raise funds through third parties. However, the patent process is not well understood, costly, and lengthy. This is particularly true for individual inventors. Many individual inventors invest large sums trying to protect concepts that turn out not to be novel. A large number of applications are abandoned after the first office action. In other cases, individual inventors abandon their application because the number of office actions can make the process too costly, or the lengthy pendency of an application can make it extremely difficult for inventors to monetize their concept.

On the receiving side of patent applications, the flood of new patent applications has created an enormous burden on patent offices, such as the United States Patent and Trademark Office (USPTO). Patent office examiners are tasked with reviewing patent applications. After conducting a search for prior art, examiners read and manually compare existing inventions and publications to the proposed patent application claims. Improvements to the quality of patent applications can reduce the number of patent application submissions that are low-quality submissions (e.g., unpatentable or overly broad).

The above-described background is merely intended to provide a contextual overview of some current issues, and is not intended to be exhaustive. Other contextual information may become further apparent upon review of the following detailed description.

### BRIEF DESCRIPTION OF THE DRAWINGS

Non-limiting and non-exhaustive embodiments of the subject disclosure are described with reference to the following figures, wherein like reference numerals refer to like parts throughout the various views unless otherwise specified.

FIG. 1 is a block diagram illustrating a networking environment for implementing patentability search and analysis of draft patent applications.

FIG. 2 is a block diagram illustrating an example of how a patent office (namely the USPTO) generally processes patent applications.

FIG. 3 illustrates an example patentability search and analysis method that can be performed a system in accordance with various aspects and embodiments of the subject disclosure.

FIG. 4 illustrates an example graphical user interface that can be used to submit search requests in accordance with various aspects and embodiments of the subject disclosure.

FIG. 5 illustrates an example graphical user interface that presents patentability search and analysis results in accordance with various aspects and embodiments of the subject disclosure.

FIG. 6 illustrates another example graphical user interface that presents patentability search and analysis results in accordance with various aspects and embodiments of the subject disclosure.

FIG. 7 illustrates yet another example graphical user interface that presents patentability search and analysis results in accordance with various aspects and embodiments of the subject disclosure.

FIG. 8 illustrates an example graphical user interface that presents results of an analysis of claims of previously filed patent applications having a same or similar patentability score to that of a submission.

FIGS. 9-11 illustrate example flow diagrams related to patentability search and analysis methods and processes in accordance with various aspects and embodiments of the subject disclosure.

FIG. 12 illustrates an example block diagram of a computer that can be operable to execute processes and methods in accordance with various aspects and embodiments of the subject disclosure.

FIG. 13 illustrates an example block diagram of an example user equipment that can be a mobile handset in accordance with various aspects and embodiments of the subject disclosure.

### DETAILED DESCRIPTION

The subject disclosure is now described with reference to the drawings, wherein like reference numerals are used to refer to like elements throughout. The following description and the annexed drawings set forth in detail certain illustrative aspects of the subject matter. However, these aspects are indicative of but a few of the various ways in which the principles of the subject matter can be employed. Other aspects, advantages, and novel features of the disclosed subject matter will become apparent from the following detailed description when considered in conjunction with the provided drawings. In the following description, for purposes of explanation, numerous specific details are set forth in order to provide an understanding of the subject disclosure. It may be evident, however, that the subject disclosure can be practiced without these specific details. In other instances, well-known structures and devices are shown in block diagram form in order to facilitate describing the subject disclosure.

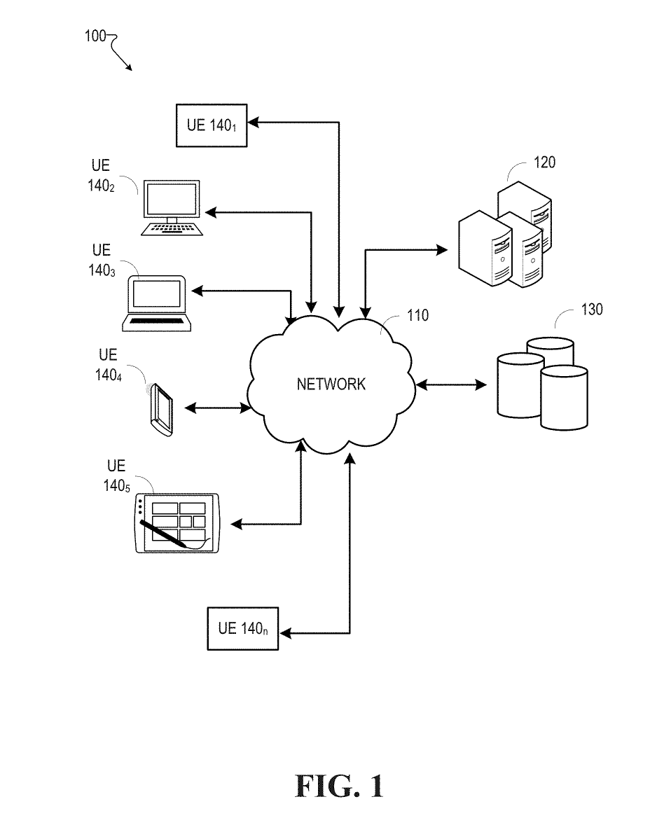

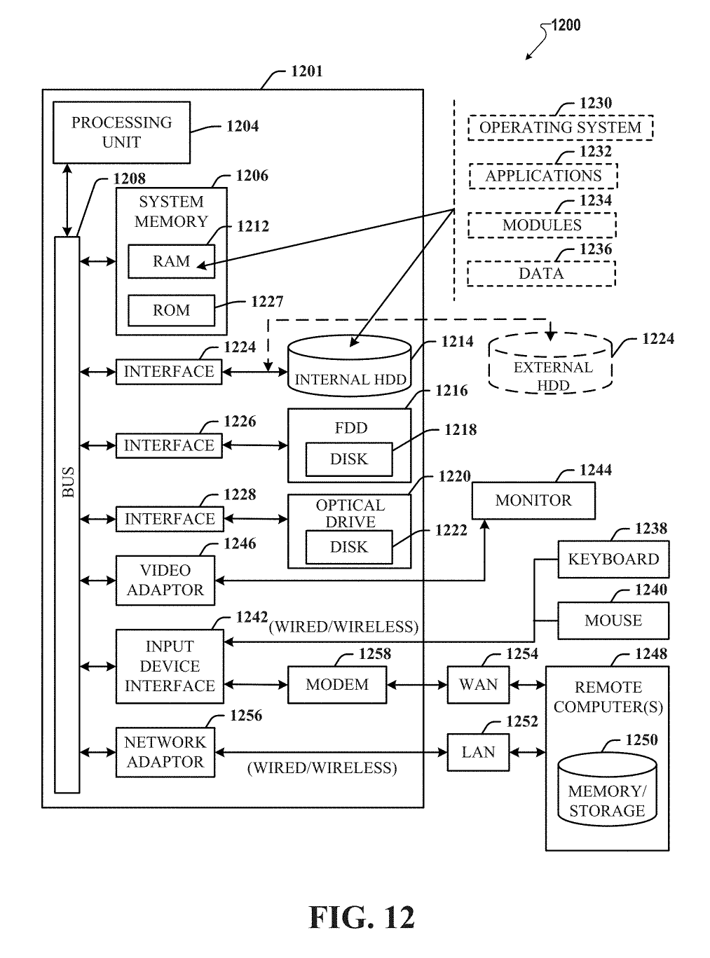

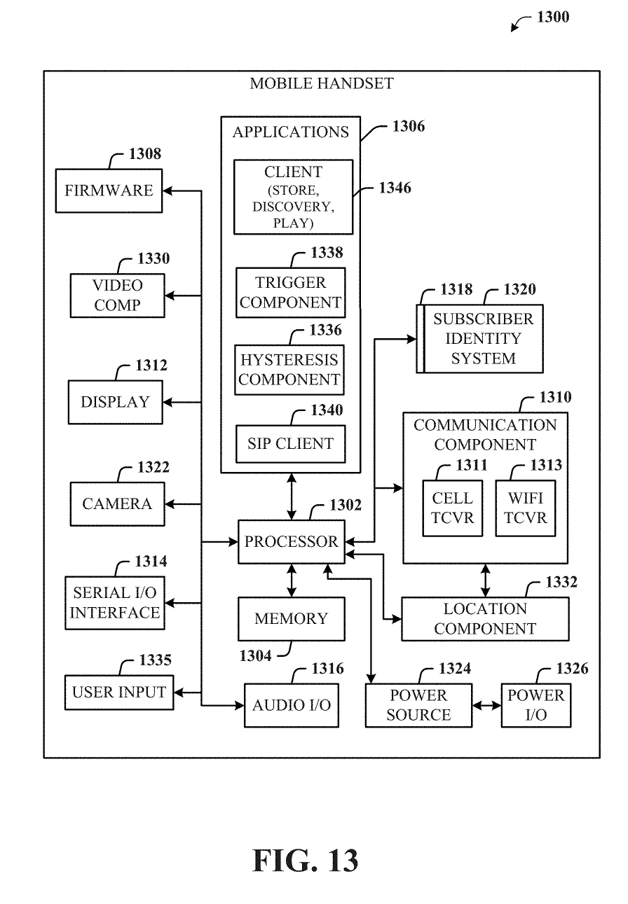

The subject disclosure of the present application describes systems and methods (comprising example computer processing systems, computer-implemented methods, apparatus, computer program products, etc.) for performing patentability search and analysis. The methods (e.g., processes and logic flows) described in this specification can be performed by devices comprising programmable processors that execute machine-executable instructions to facilitate performance of the operations described herein. Examples of such devices can be as described in FIG. 1, and can comprise circuitry and components as described in FIG. 12 and FIG. 13. Example embodiments may take the form of an entirely hardware embodiment, an entirely software embodiment, or an embodiment combining software and hardware aspects.

Example embodiments are described below with reference to block diagrams and flowchart illustrations of methods, apparatuses, and computer program products. Steps of the block diagrams and flowchart illustrations support combinations of mechanisms for performing the specified functions, combinations of steps for performing the specified functions, and program instructions for performing the specified functions. Example embodiments may take the form of web, mobile, wearable computer-implemented, computer software. It should be understood that each step of the block diagrams and flowchart illustrations, combinations of steps in the block diagrams and flowchart illustrations, or any functions, methods, and processes described herein, can be implemented by a computer executing computer program instructions. These computer program instructions may be loaded onto a general-purpose computer, special purpose computer, combinations of special purpose hardware and other hardware, or other programmable data processing apparatus. Example embodiments may take the form of a computer program product stored on a computer-readable storage medium having computer-readable instructions (e.g., software) embodied in the storage medium. Any suitable computer-readable storage medium may be utilized including, for example, hard disks, compact disks, DVDs, optical storage devices, and/or magnetic storage devices.

The present application provides for a patentability search and analysis system that can, in example embodiments, utilize the same search tool(s) as used by patent office examiners after the draft patent application has been filed (e.g., submitted to a patent office). By incorporating search tools used (e.g., approved, authorized, designated, endorsed, and/or utilized) by a patent office, the search and analysis system can allow a user (e.g., a user identity, which might be a potential patent applicant such as an inventor or assignee, or a representative of the potential applicant such as a patent agent or patent attorney) to discover some of the same art references (also referred to as prior art, prior art references, prior references, etc.) that the patent office might discover. This can serve to eliminate weaker patent filings and lead to an increase in the quality of patent filings because many weak applications might not be filed, or can be improved before filing. This can allow examiners to spend more time focusing on examining stronger applications and less time rejecting weaker applications. Public access to the tool can provide a user a more transparent patent process, allowing users to obtain a preview as to relevant prior art before formally filing the draft application with a patent office. Additionally, users can better determine the novelty of their concept before investing significant dollars in the filing of a patent application.

As will be described further herein, the search and analysis system can be operable to allow a user identity to initiate and perform a patentability search and analysis by submitting a description of concepts, a summary, claim terms (also referred to as patent claims), or a draft patent application (which also comprises claim terms). Additionally, the search and analysis system include features that allow a user to select particular search engines, select the databases of art to search, and enter additional art for consideration (including art cited in related applications). The search and analysis system can also be operable to identify the likely art unit of a patent office that is likely to be assigned to examine the draft patent application after the patent application has been filed, and also identify and consider art references cited most often by the likely art unit. In example embodiments, the search and analysis system can also determine a likely patent examiner that will examine the patent application for the concept or claims, and can identify and consider the references most often cited by that patent examiner

The search and analysis system can also, based on the submitted description, summary, claims, or application, perform a patentability search that finds prior art relevant to the submission. In some example embodiments, the search and analysis system can also be operable to categorize the art references as art that anticipates the invention, or would anticipate the invention if combined with other art (e.g., § 102 art, or § 103 art in the United States of America, or § 28.2 and § 28.3 art references in Canada, etc.).

The search and analysis system can also, based on the prior art found, relevancy of the art, determine a patentability indicator (e.g., a patentability score) representative of the likelihood that a patent will be granted on a patent application representative of the submission (e.g., assessment of patentability). The system can also, based on an analysis of prior publicly filed patent applications, provide the rejection and allowance rates for other patents (e.g., the claims of those applications) having a patentability score that is similar the patentability indicator. The rejection and allowance rates can be for the patent office as a whole, the art unit, or the examiner Additionally, the system can provide a “confidence level” representative of the strength of the patentability indicator, based on a variety of criteria (discussed below). The system is also operable to change the value of the patentability indicator based on, for example, a selection by a user indicating that a particular art found through the search should be removed from consideration.

The search and analysis system can also be operable to identify deficiencies and other issues related to a draft of a patent application. The user is thus able to determine whether to proceed with the filing of the application, revise his or application, and remedy any potential deficiencies with the application.

FIG. 1 is a diagram illustrating an example network environment 100 in which the methods and functions described herein can be implemented. According to example embodiments, a patentability search and analysis system in accordance with the present application can comprise one or more servers and user equipment that comprise a processor and a memory that stores executable instructions (e.g., computer code, software modules, software program, software application, computer program product, etc.) that, when executed by the processor, facilitate performance of operations, functions, or steps as described herein.

As may be understood from FIG. 1, the network environment 100 can comprise one or more computer networks 110, one or more servers 120, one or more storage devices 130 (which may contain one or more databases of information), and one or more user equipment (UE) 140₁₋ₙ. (also referred to herein as user equipment 140). UE 140 can comprise, for example, a tablet computer, a desktop computer, or laptop computer, a cellular enabled laptop (e.g., comprising a broadband adapter), a handheld computing device, a mobile phone, a smartphone, a tablet computer, a wearable device, a virtual reality (VR) device, a heads-up display (HUD) device, and the like. Servers 120, storage devices 130, and UE 140, may be physically located in (or in the case of mobile devices, can be temporarily present in) a central location, such as the headquarters of the organization (e.g., a patent office), for example, or in separate facilities (e.g., different offices of the patent office). A UE may be owned or maintained by employees, contractors, or other third parties (e.g., a cloud service provider). In example embodiments, the one or more computer networks 110 facilitate communication between the server(s) 120, storage device(s) 130, and UE 140.

The one or more computer networks 115 may include any of a variety of types of wired or wireless (e.g., cellular, satellite, etc.) computer networks such as the Internet, a private intranet, a public switched telephone network (PSTN), cellular network, data over cable network (e.g., operating under one or more data over cable service interface specification), or any other type of computer or communications network. The communications networks can also comprise, for example, a Local Area Network (LAN), such as an office or Wi-Fi network.

Thus, in example embodiments, the network environment 100 of the present application can comprise a user device (e.g., UE 140) running a webpage that can access and communicate, through one or more communications networks (e.g., network 110), with one or more servers (e.g., servers 120) and/or user devices (UE 140), wherein the web-executable programs can search through or access data stored in one or more databases in repositories (e.g., storage devices 130) and perform other steps and functions as described herein.

In example embodiments, the search and analysis system of the present application can comprise computer software (e.g., software application, software modules, software programs, etc.) that can run, for example, on a user's computing device (e.g., UE 140₁₋ₙ). The computer software can be an application installed on the user equipment, or can also comprise web-executable programs (e.g., servlets, applets, etc.), with functionality provided by one or more servers (e.g., servers 120) that operate in conjunction with the computer software that execute on the user equipment to perform the various functions, methods, and steps described herein.

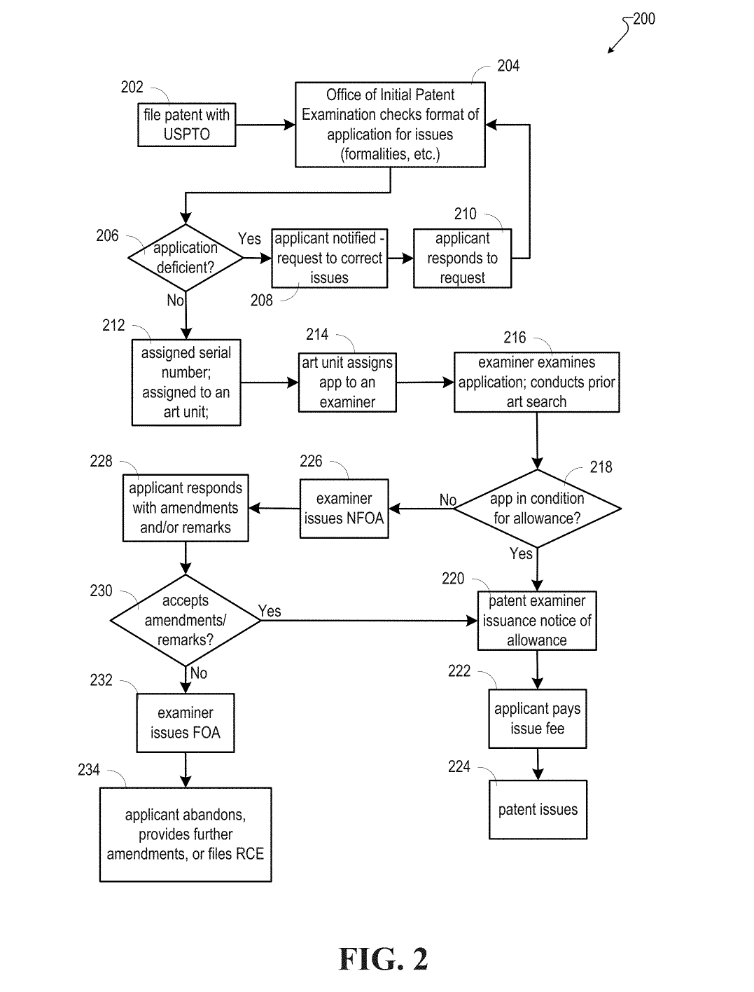

FIG. 2 depicts a flow diagram 200 showing an overview of an example of how a patent application is largely processed by a patent office, and in particular, the United States Patent and Trademark Office (USPTO). While this overview in FIG. 2 serves as an example of how patent applications are processed by the USPTO for illustration purposes, at least some other patent offices in the world implement a process similar to that of the USPTO (e.g., Japan, India). In example embodiments, the search and analysis system as described herein can be operable to provide searching and analysis based on the rules and procedures of the patent office of a particular country in response to a user's selection of that country's particular patent office.

At step 202, a patent application can be electronically filed (e.g., filed by an applicant, which might may be, for example, an inventor, an assignee of the patent application, representative of the inventor, representative of the assignee, etc.) with the USPTO. Once filed, at step 204, the office of initial patent examination (OIPE) of the USPTO can check the format of the application for deficiencies, such as errors, informalities and other potential procedural and/or non-substantive issues. In response to a determination by the OIPE that the patent is deficient at step 206, the applicant of the patent application can in step 208 be notified and requested to correct the deficiency. The applicant can, at step 210, respond by correcting the deficiencies.

After the user responds, the process can move back to steps 204 and 206, where the application can be checked again and a determination can be made regarding the patent application's deficiencies.

In response to a determination at step 206 that the patent application is not deficient, the process can move to step 212, wherein the patent application can be assigned to an art unit.

Still referring to FIG. 2, at step 214, the art unit assigns the application to a patent examiner. At step 216, the examiner can examine the patent application and can conduct a patentability search in which the examiner attempts to find prior art to the patent application. Typical search tools used by a patent examiner to conduct a patentability search include the Examiner's Automated Search Tool (EAST), and Web-based Examiner's Search Tool (WEST). The examiner can examine each reference found and manually determine whether each claim is patentable over the prior art that was found through the search and whether the patent application is otherwise in a condition for allowance (e.g., ready to be issued as a patent). Typically, an examiner might take a position that one piece of prior art anticipates the claims of a submitted application (e.g., a § 102 rejection). Alternatively, or additionally, an examiner might reject the claims on obviousness grounds (e.g., § 103 rejection), which could be based on examiner's position that a combination of references in view of each other teaches the claims as recited in the submitted application.

If at step 218 the examiner determines that the patent application is in a condition for allowance, the examiner can at step 220 provide a notice of allowance to the user, which is a correspondence informing the user that his patent has been approved for issuance. The applicant can at step 222 pay an issue fee to the USPTO. At step 224, in response to receiving the payment, the patent application can issue as a patent.

If at step 218 the examiner determines that the patent application is not in a condition for allowance, the examiner can, at step 226, issue a rejection notice (e.g., a non-final office action) in which the examiner sets forth in a correspondence the reasons why the patent application is not in a condition for allowance. At step 228, the applicant can respond to the non-final office action by providing remarks, or by amending the application (e.g., by revising the claims) and providing remarks.

If the examiner at step 230 finds the response or amendments satisfactory, then at step 220 the examiner can issue a notice of allowance to the applicant.

If the response is not satisfactory, the examiner can issue a final office action rejection, to which the applicant can respond with further amendments, appeal the rejection, file a request for continuing examiner (RCE), etc.

As mentioned above, applicants often do not conduct a patentability search prior to the filing of a patent application. A search by a patent examiner can typically result in the discovery of art references that would have been discovered had a search been conducted prior to the filing of the application.

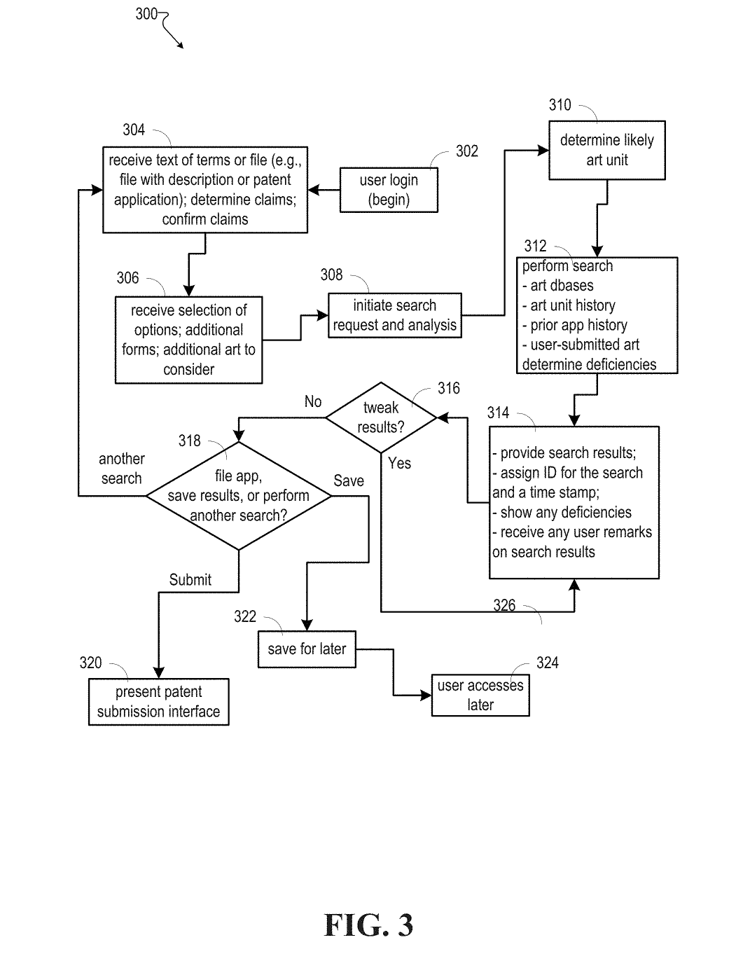

Now referring to FIG. 3, example embodiments of a process 300 that can be performed by the search and analysis system.

The process 300 can begin at block 302, whereby a user login request can be received (e.g., received by search and analysis system). The login request may be received from a computer (e.g., UE 104) operated by a user. The user can be, for example, the inventor of the subject matter of the patent, a representative of the inventor, an assignee of the patent, or a representative of the assignee of the patent (e.g., a patent lawyer or patent agent). In example embodiments, the search and application search system can be accessible after the user logs into (e.g., accesses) the system.

At step 304, the search and analysis system can be operable to receive a submission that can be used as a basis for a patentability search. The submission can be received from, for example, inputs made by the user. In example embodiments, an entry field can be displayed that allows the user to enter in search terms, or a patent claim. A user can submit into the entry field the terms related to his or her invention, a description of his or her invention (which may be detailed or brief), or a summary of his or her invention. The entry field can be populated via keystrokes or taps from a user input device (e.g., via a keyboard, keypad, virtual keyboard, stylus, etc.).

The search and analysis system can also be operable to allow the user to upload a description of his or her invention (for example, in a text file, document, or PDF file). In example embodiments, a user can also upload a draft patent application (e.g., which includes a draft of a patent application intended to be filed with a patent office) for the patentability search and analysis system. The draft patent application can comprise, for example, a disclosure with claims, drawings, application data sheet, oath and declaration, etc. In example embodiments, the user can use a draft patent application builder program module that is part of the patentability search and analysis system that can assist with the assembly and generation of a draft patent application. The patent application builder program can take the form of, for example, a step-by-step wizard, that asks the inventor to enter in a title, brief description of drawings, description of example embodiments, claims, etc.

At step 306, in response to a file containing a description being uploaded, the search and analysis system can be operable to analyze the file and determine a set of terms representing a summary or excerpt of the description of the inventive concepts. Such algorithms are known to those of skill in the art, and can be incorporated into the search and analysis system. The terms can then be displayed to the user in an entry field so that the user can review the terms and make any edits to the terms as desired by the user. A caption can be displayed, such as, “Your submission has been analyzed and the following terms appear to be representative of your inventive concepts. Please add to, remove, or edit these terms if needed.”

In response to a draft patent application being uploaded, the search and analysis system can be operable to identify and extract the claims from the draft patent application, which can then be used to perform a patentability search. In example embodiments, the search and analysis system can use an algorithm that is able to recognize the text of the application, and use indicators (such as the words “I claim,” “We claim,” or “What is claimed is” to determine the location of the claims in the application. In example embodiments, the search and analysis system can present the extracted claims to the user, and receive a confirmation from the user that the extracted claims are the same claims that were submitted in the draft patent application. If they were not the same claims, the user can be presented with an option to enter the correct claims, or re-scan the disclosure for extraction of the claims. In other example embodiments, once extracted, the search and analysis system can display the claims or claim terms to the user in an entry field so that the user can review the terms and make any edits to the terms as desired by the user. A caption can be displayed, such as, “Your submission has been analyzed and the following terms appear to be representative of your inventive concepts. Please add to, remove, or edit these terms if needed.” The search and analysis system can then allow the user to remove or edit any terms as desired by the user.

At step 306, the search and patentability system can present prompts for and receive a selection of options by the user related to the patentability search. Among the options are that the search and patentability system can be operable to allow a user to select particular search engines, select the databases of art to search (e.g., patents, literature, trade journal articles, foreign art, etc.).

In example embodiments, the user can also select one or more search engines that the patentability search can employ. These search engines can include commercially available patentability search tools.

In example embodiments, a user can select one or more databases that can be searched. The search and analysis system can present a user with a drop-down menu showing a list of databases of art that can be searched. Alternatively, or additionally, the user can enter a keyword into a field and the search and patentability system can present for selection any databases that match the user's entered keyword.

If no selections as to search engine or database are selected by the user, the search and analysis system can be operable to use as a default typical search engines and databases of art used by a selected country's patent office.

The search and analysis system can also be operable to allow a user to select the country in which the draft patent application will be filed. Upon receiving a user selection, the search and analysis system during the patentability search can apply the patentability rules of that country (e.g., whether prior art is based on first to file or first to invent, etc.).

Still at step 306, the user can also enter in any additional art that the user would like to have the patentability search and analysis system analyze for relevance to the draft claims. In example embodiments, the search and patentability system can prompt a user to enter additional art for consideration (including art cited in related applications) as part of the patentability search. Thus, if a user knows of relevant or background art that the user might want to submit so that the search and analysis can include that art, the search and patentability system can allow for the entry of that art.

The user can submit the patent or application numbers of any parent applications or related applications/publications so that art references considered or cited during the prosecution of those patents can be electronically retrieved and analyzed as part of the search. In example embodiments, the search and patentability system can be operable to prompt for, and receive, a user's entry of a patent number, publication number, application number, or some other identifier associated with a related application that had been filed with a patent office. The search and analysis system can the retrieve the art or a list of the relevant art that was cited in the related application. The use can indicate the prior art cited in the related application that the user desires the current patentability search to cover, for example, by selecting or checking boxes that appear next to the listed cited art reference(s).

If the user does not submit art or related patent information, the patentability search can proceed without consideration of these choices.

In example embodiments, in addition to terms and/or a draft patent application being submitted, any other forms required by the patent office (e.g., an application data sheet, declaration, assignment, etc.) can also uploaded by the application into the search and analysis system. The search and analysis system can be operable to determine if there are any deficiencies with the application or the forms (e.g., missing inventor's last name, etc.).

At step 308, the user can make a selection (e.g., a hyperlink, a button etc.) indicating a command to perform a patentability search and analysis. The search and analysis system accepts the user's selection to proceed with the patentability search and analysis.

At step 310, in example embodiments, based on the claims submitted or extracted (and other information, such as title and abstract), at step 410, the patentability search and analysis system can determine the likely art unit to which draft patent application related to the submission might be assigned if the draft patent application is filed with the patent office. This determination can be used to identify art references that examiners in the likely art unit frequently cite and consider during the patent examination process. In example embodiments, the search and analysis system can also determine a likely patent examiner that will examine the draft patent application for the concept or claims, and can identify and consider the references most often cited by that patent examiner.

At step 312 a patentability search can be performed by the search and analysis system. The patentability search and analysis system can employ the use of a patentability search tool comprising one or more search engines that can search one or more databases of information for art references that might be might be relevant to the claims of a draft patent application related to the submission if the draft patent application is filed with the patent office. The patentability search tool can comprise one or more search engines that can search one or more databases of information for art references that might be relevant to the claims of the patent application. The patentability search tool can comprise operability that allows for a variety of types of searching, including natural language, Boolean, the like. The searches can also be based upon similar words (e.g., a claim that recites “connected” can result in a search using the term “coupled.”). Examples of patentability search tools comprise search engines available at a patent office (e.g., United States Patent and Trademark Office at www.patf.uspto.gov), other online search tools (e.g., at www.patentssearcher.com, www.espacenet.com, http://patents.google.com, PatentSearcher.com), and search tools offered commercially by third parties (e.g., Innography, LexisNexis Total Patent, Thomson Innovation, PatBase). In example embodiments, the patentability search tool can comprise an aggregator that gathers results from multiple search engines. Based on the information entered, results from multiple patentability search tools and databases can be obtained. The patentability search tools can employ a variety of algorithms and techniques, comprising key word analysis, natural language searching, use of ranking factors, chemical structure searches, graphical patent family analysis, etc.

Still referring to FIG. 3 step 312, example tools can allow for searching through many different databases, many of which might not be maintained by the patent office. The databases can be stored in, for example, storage devices 130. These databases can comprise various art literature such as patents, trade journal articles, and the like. Examples of such databases comprise Biosciences Information Service (BIOSIS) Previews, Environmental Science Collection, History of Science, Technology and Medicine, Institute of Electrical and Electronics Engineers (IEEE) Explore, etc. The system's patentability search can also retrieve and analyze any art frequently cited by the likely art unit to which the subsequently filed patent application will most likely be assigned, any art that was submitted by the user, and any art that was considered or cited during prosecution of the related apps (which can be determined if the user submitted the patent or application number of a related patent, or the user submitted a data sheet having any such number).

As an example, if the submitted claims comprise chemical formulas or chemistry-related elements, the search tool can search through chemistry-relevant databases (e.g., trade journals published by chemistry, chemical engineering, and biochemistry societies), or perform a chemical structure search. Likewise, if a plant or design patent is uploaded for search and analysis, a different database can be used relevant to plant and design patents.

At step 312, the patentability search can also comprise an analysis to determine whether the claims or draft patent application contains deficiencies such as errors, informalities, missing information, missing sections of the draft patent application specification, lack of antecedent basis, non-compliant drawings, lack of support in drawings and descriptions, differentials in claims and descriptions, wrong part numbers, incorrect claim numbers, ambiguous and potentially indefinite terms, ineligible subject matter, likelihood of a restriction requirement, and other potential issues. Examples of tools that can analyze a draft patent application and discover deficiencies are Patent Optimizer, which is proprietary to LexisNexis, and ClaimMaster.

At step 314, the results of the patentability search can be returned (e.g., returned by search and analysis system). In example embodiments, the system can retrieve and generate for display the results on a GUI. The results can comprise the document and the relevant date of the art (e.g., the filing date, the publication date, etc.). In some example embodiments, the search and analysis system can also be operable to categorize the art as § 102 art (e.g., art that anticipates the invention), or § 103 art (art that would anticipate the invention if combined with other art). If each, or a substantial number, of the relevant terms (e.g., excluding articles) of the search, which may be claim terms, is found in a single document, that document might be classified by the search and analysis system as § 102 art. The search and analysis system might decide that some of the keywords are not in the § 102 art, but still considers it § 102 art, and indicates by a relevancy indicator (e.g., percentage level) the chance or probability that the art is § 102 art. The search and analysis system can also determine that other references in the same field of art (e.g., based on recitations such as “cyber security” or “cable communications”) have one or more elements of the entered and submitted search terms (e.g., claim terms), such that when combined, and in view of each other, or in view of the § 102 art reference(s), would render the concept (or claims) obvious. As with the § 102 art, the search and analysis system can provide an indicator of relevance of the § 103 art (e.g., by percentage). The percentage can be based on, for example, the frequency with which relevant terms appear in the document, or whether the documents contains words that teach the combinability of the reference with other references (e.g., “can be integrated with.”).

The search and analysis system can also, based on the prior art found, relevancy of the art, determine an overall patentability indicator (e.g., a patentability score) representative of the likelihood that a patent will be granted on a patent application representative of the submission (e.g., assessment of patentability). The system can also, based on an analysis of prior publicly filed patent applications, provide the rejection and allowance rates for other patents (e.g., the claims of those applications) having a patentability score similar the patentability indicator for the submission. For example, the patentability scores for the claims can be of the same value as the patentability indicator for the submission. For example, the patentability scores for the claims of those applications can also be a number substantially similar to the patentability indicator. The patentability scores for the claims can also be, for example, the next closest value to the patentability indicator for the submission. The rejection and allowance rates can be for the patent office as a whole, the art unit, or the examiner. Additionally, the system can provide a “confidence level” representative of the strength of the patentability indicator, based on a variety of criteria (discussed below).

If a draft patent application was submitted for search and analysis, the results, which can be displayed to the user, can also comprise any deficiencies in the claims, or application (e.g., lack of antecedent basis, mis-numbering of figures, missing sections, unfilled required fields in forms, etc.).

Examples of search results are presented further below with respect to several user interface views.

At step 316, in example embodiments, the user is able to, at step 316, tweak some of the results. The search and analysis system can be operable to change the value of the patentability indicator based on, for example, a selection by a user indicating that a particular art found through the search should be removed from consideration. If the user opted to tweak the results, then the method proceeds to step 314 again where updated results are displayed.

Still referring to FIG. 3, at step 318, after the user has reviewed the search results, an input can be received (e.g., received by the search and analysis system) indicating that the user desires to continue with the filing of the draft patent application, that user desires to save the search results and log in at a later time, or that the user desires to perform another search.

If it is determined at step 318 that the user has input a command (e.g., selection of the appropriate on-screen button) to continue with the filing of the draft patent application, the search and analysis system at step 320 can generate for display on the user's computer an electronic patent submission interface, which the user can log into. In example embodiments, the user can log into his or her account that is used for filing patents and accessing patent information. An example of a user login accessible on-line account for filing patents and obtaining patent information is the USPTO's web-accessible electronic filing system (EFS-Web), maintained an operated by the USPTO.

Still referring to FIG. 3, in example embodiments, in response to an input of a command indicating that a user desires that the pre-filing patentability search results be saved, at step 322 the patentability search can be saved (e.g., saved by the system). Once saved, the user can at step 424, access the patentability search results at a later time. As mentioned above, the user may want to refer to the search results when revising the claims, or perhaps want to confer with others regarding the search results (e.g., a patent agent conferring with the inventor).

The patentability search and analysis system at step 318 can also be operable to receive an input indicating that the user desires to perform another patentability search, and as such, the method can move back to step 304, wherein the user make another submission, or modify the previous submission. The user can choose to perform another search based on the revisions, and the system can receive another submission of either terms, claims, a file with a description, or a draft patent application. If no revisions are made the user can still proceed with the filing of the draft patent application.

Optionally, an identifier (e.g., an indicator, data element, flag, bit setting, frame, etc.) can be assigned or associated with an application in which a pre-filing patentability search was performed. In example embodiments, an alphanumeric search identification number (search ID#) can be assigned to the application (in some embodiments, the search results can be accessed at a later time using the search ID#), and a time stamp can also be associated with the pre-filing patentability search (e.g., indicating the time at which the search results were returned by the system). In example embodiments, the patentability search ID# can be automatically populated in a field in the application data sheet, or entered into a separate field and associated with the application data representative of the draft patent application when the draft patent application is filed.

A patent office, should it choose to implement such a process, can use the search ID# and time stamp indicating that a pre-filing patentability search has been performed and that a patent application has been filed within a designated period shortly thereafter (e.g., “shortly thereafter” can be any designated period, such as a week, two weeks, a month, six months, etc.), to advance the patent application in priority ahead of other patent applications that were submitted without a pre-filing patentability search.

In example embodiments, if the designated period has elapsed, the search ID# associated with the search can be expunged from the search and analysis system, along with the search results. Additionally, any flag, bit setting, indicator, or other data element indicating that a pre-filing search was conducted for the application can be toggled, or removed, to indicate that the application was not timely filed after the pre-filing patentability search was performed. In example embodiments, the search and analysis system can discard the search ID# on the list of recent search results (e.g., such that the search ID# is no longer an indicator that a pre-filing patentability search was performed within the requisite time period). The search and analysis system can alert the user that the search result has expired and can no longer be used to advance the priority of the examination if the patent application is submitted at this time. The system can also, for example, display a notification to the user informing the user that he or she can perform another search to obtain a new search ID#.

In example embodiments, if it is determined at step 426 that a specified period (e.g., a week, a month, etc.) has elapsed between the time the search results were made available to the user and the time at which the user either logged in to access the search results later (or attempts to file the application), the search ID# associated with the search can be expunged from the system, along with the search results. Or, the system can discard the search ID# on the list of recent search results (e.g., such that the search ID# is no longer an indicator that a pre-filing patentability search was performed within the requisite time period). The system at step 428 can inform the user (e.g., generate an on-screen notification) that the search result has expired and can no longer be used to advance the priority of the examination if the draft patent application is attempted to be submitted. The system can also, for example, display a notification to the user informing the user that he or she can perform another search to obtain a new search ID#. In example embodiments, the user also has the option to proceed without revisions, or without conducting a new search. If a search is outdated, optionally, it can be discarded as not having information representative of the current or complete body of current publications or other art. Additionally, the system (e.g., system) is operable to receive commands from a user to select any previous search result for deletion from the system.

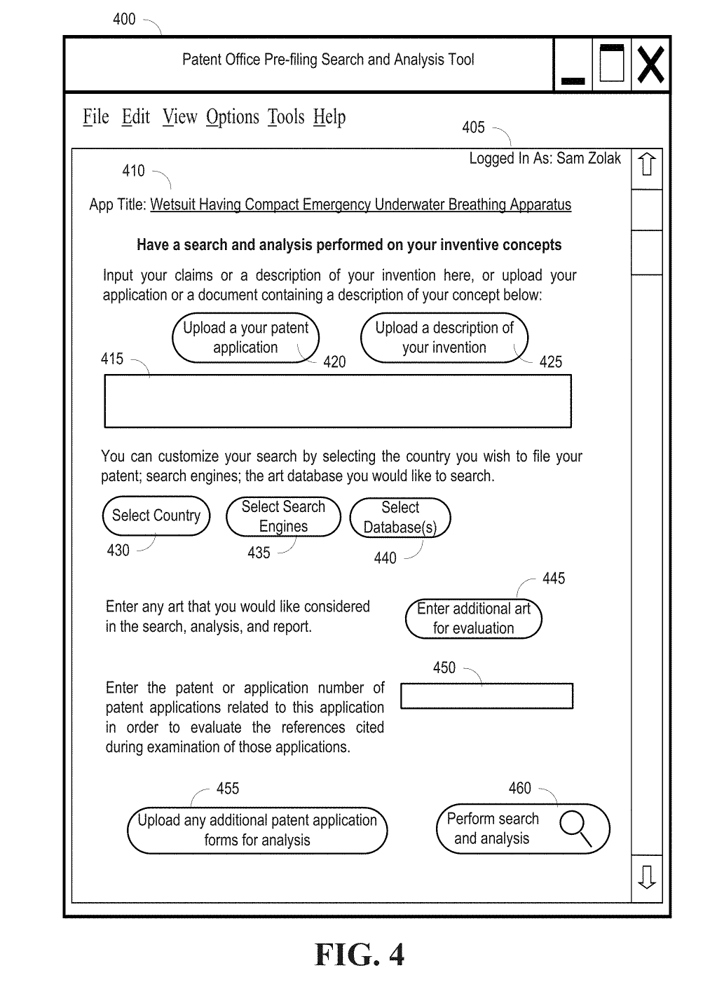

FIG. 4 illustrates an example of a GUI operable to allow for submissions for patentability search and analysis. The patentability search and analysis system (e.g., system) can be operable to generate a patentability entry GUI 400. In example embodiments, after logging in to a patent office electronic filing system, a user can enter a title for the patent to be filed. The GUI 400 (which can be a web page, a web dialog, etc.) can show the login name 405 of the user, and can also show the title 410 of the application.

In example embodiments, an entry field 415 can be displayed that allows the user to enter in search terms, a summary of his or her inventive concepts, or one or more patent claims. The entry field 415 can be populated via keystrokes or taps from a user input device (e.g., via a keyboard, keypad, virtual keyboard, stylus, etc.).

Still referring to FIG. 4, through GUI 400, a user can, by selecting the “Upload your patent application” button” 420, upload a draft patent application for the patentability search and analysis system to analyze. The draft patent application can comprise, for example, a disclosure with claims, drawings, application data sheet, oath and declaration, etc. The patentability search and analysis system can be operable to identify and extract the claims from the draft patent application, which can then be used to perform a patentability search. In example embodiments, the patentability search and analysis system can present the extracted claims to the user (e.g., present the claims in field 415), so that the user can confirm that the extracted claims are the same claims that were submitted in the draft patent application. A caption can be displayed (e.g., in a GUI dialog box) having text such as, “Your submission has been analyzed and the following terms appear to be representative of your inventive concepts. Please add to, remove, or edit these terms if needed.” The search and analysis system can then receive any edits to the displayed claims prior to submission for the patentability search and analysis.

Still referring to FIG. 4, the search and analysis system can present on GUI 400 an “Upload a description of your invention” button 425, in response to a file containing a description being uploaded, the search and analysis system can be operable to analyze the file and determine a set of terms representing a summary or excerpt of the description of the inventive concepts. Such algorithms are known to those of skill in the art (e.g., a text summarization tool available from Salesforce corporation), and can be incorporated into the search and analysis system. The terms can then be displayed to the user in entry field 415 so that the user can review the terms and make any edits to the terms as desired by the user. A caption can be displayed, such as, “Your submission has been analyzed and the following terms appear to be representative of your inventive concepts. Please add to, remove, or edit these terms if needed.”

The search and analysis system can also be operable to allow a user to select the country in which the draft patent application will be filed by generating, for example, the “Select Country” button 430. Upon receiving a user selection, the search and analysis system during the patentability search can apply the patentability rules of that country (e.g., whether prior art is based on first to file or first to invent, etc.).

Still referring to FIG. 4, in example embodiments, the user can also select one or more search engines, for example by selecting the “Select Search Engines” button 435, that the patentability search will use. These search engines can include commercially available search tools/engines and can be incorporated as a module in the patentability search and analysis system, or a module that the patentability search and analysis system calls upon to perform the search.

The user can also select one or more databases that can be searched by selecting the “Select Database(s)” button 440. As mentioned above, many databases contain relevant art, including to a particular industry.

If no selections as to search engine or database are selected by the user, the search and analysis system can be operable to use as a default typical search engines and databases of art used by a selected country's patent office.

By selecting the “Enter Additional Art for Evaluation” button 445, the system through GUI 400 also allows a user to enter any additional art that the user would like to have the patentability search and analysis system analyze for relevance to the terms or draft claims. In example embodiments, upon selection of the Enter Additional Art button 445, the user can upload a document, provide a hyperlink to a document (or to a webpage), provide a patent number, or upload a draft of an information disclosure statement (IDS). The search and analysis system can be operable to scrape a website, or extract information from any uploaded documents.

Still referring to FIG. 4, if a document was identified or specified (e.g., by name, identifier, reference, etc.) instead of being uploaded, the patentability search and analysis system can obtain the document using the specified or identified information (for example, if a U.S. patent number is provided, the system can obtain the patent through the USPTO's website). Additionally, if an uploaded document has not been optical character recognized (OCR'd), the system can automatically perform that function so that the document can be searched and analyzed.

Additionally, in example embodiments, the user can submit, via the related patent entry field 450, the patent or applications numbers of any related applications (e.g., parent, divisional, continuation, or continuation-in-part applications), so that art references considered or cited during the prosecution of those related patents can be analyzed as part of the search.

If the user does not submit art or related patent information, the search and analysis can proceed without consideration of these choices.

In example embodiments, in addition to terms and/or a draft patent application being submitted, any other forms required by the patent office (e.g., an application data sheet, declaration, assignment, etc.) can also be uploaded into the patentability search and analysis system. The search and analysis system can generate GUI 400, for example, a “Upload any additional patent application forms for analysis” button 455. As mentioned above, in addition to performing an analysis to determine whether the claims or draft patent application contains deficiencies such as errors, informalities, missing information, non-compliant drawings, and other potential procedural and/or non-substantive issues, the search and analysis system can be operable to determine if there are any deficiencies with draft patent application forms (e.g., missing inventor's last name, etc.).

The search and analysis system can generate in GUI 460 a “Perform search and analysis” button 460 so that the user can enter a command to perform a patentability search and analysis. The search and analysis system then accepts the user's command to proceed with the patentability search and analysis.

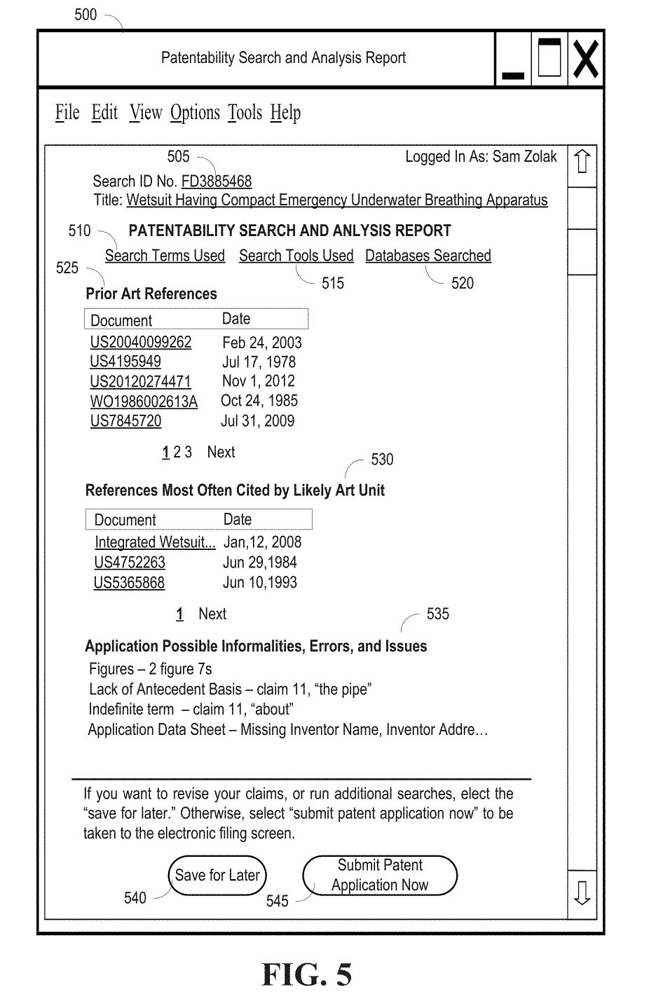

FIG. 5 illustrates an example of a GUI 500, which can be generated by the search and analysis system for displaying the results of a patentability search and analysis. In example embodiments, the search and analysis system can retrieve and generate for display the results of the patentability search results on a GUI 500. The GUI 500 can display an identifier 505 that can be assigned to the patentability search and analysis report, such as an alphanumeric search identification number (search ID#) so that the search results can be accessed at a later time.

From this example screen, the user can select the “Search Terms Used” link 510 to see the search terms (which can be one or more claims) that were used to generate the search. The user can also select the “Search Tools Used” link 515 to see the search tools/engines used to conduct the search (e.g., an on-line search tool, a commercially available search tool, etc.). Selecting the “Databases Searched” link 520 can show the databases that were searched.

The displayed results of GUI 500 can comprise a listing of each found document and the relevant date of the art (e.g., the filing date, the publication date, etc.), as shown in FIG. 5 in the “Prior Art References” section 525. In response to the user selecting one of the documents, the search and analysis system can retrieve and display the selected reference.

GUI 500 also shows in the “References Most Often Cited by Likely Art Unit” section 730 the references that would be most likely cited if a filed patent application was assigned to the particular art unit of a patent office most likely to examine the draft patent application after the draft application is filed with a patent office (if the user were to choose to file the draft application).

The results shown in GUI 500 can also comprise any deficiencies in the claims or application. In the example shown, section 535 displays an example of some of the deficiencies that were identified in a search.

As shown in GUI 500, a user can select the “Save for Later” button 540 to save the patentability search result. Once saved, the user can access the patentability search results at a later time. As mentioned above, the user might want to refer to the search results when revising the claims, or perhaps might want to confer with others regarding the search results (e.g., a patent agent conferring with the inventor).

If the user selects the “Submit Patent Application Now” button 545, the system can generate for display on the user's computer an electronic patent submission interface. In example embodiments, if a draft patent application was submitted for into the patentability search and analysis tool, the draft patent application (e.g., patent description, claims, drawings, application data sheet, etc.) can be transmitted (or forwarded or transferred over) via an electronic patent submission interface.

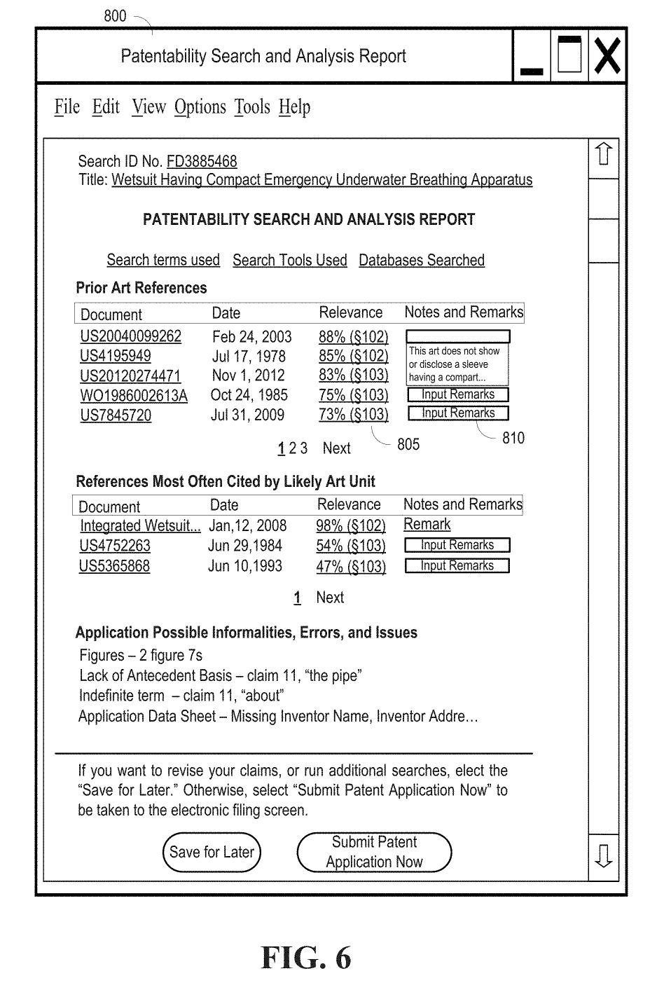

Moving to FIG. 6, another example embodiment of a patentability search and analysis GUI 600 is shown. This GUI 600 is similar to the one presented in FIG. 5. Unlike FIG. 5, in which there is no record of any assessment of the prior art and its relevancy to any potential claims of a draft patent application, in FIG. 6, a relevancy value is associated and displayed with each art reference identified in the patentability search. The system can assign a relevancy value based on any variety of relevancy determining algorithms known to those of ordinary skill (e.g., frequency of terms, proximity of terms, etc.). The results can also show for each art reference the patent law(s), rule(s), or regulation(s) that might relate to its use as a basis for the rejection. For example, a reference might be a basis for a lack of novelty rejection, categorizing it as § 102 art (e.g., art used to support a lack of novelty rejection based on 35 United States Code § 102). The search and analysis system can be operable to categorize (or categorize the likelihood of) the art as § 102 art (e.g., art that anticipates the invention).

If a particular reference contains all, or a substantial number of the terms recited in an independent claim, it might be identified as a possible § 102 reference. That is to say, if each, or a substantial number, of the relevant terms (e.g., excluding articles) of the search, which may be claim terms, is found in a single document, that document might be classified by the search and analysis system as § 102 art. The search and analysis system can provide an indicator of relevance of the § 102 art (e.g., by percentage). The percentage can be based on, for example, the frequency with which relevant terms appear in the document and/or the order, sequence, or nearness of certain relevant terms with other relevant terms. The search and analysis system might determine that some of the keywords are not in the § 102 art, but still considers it § 102 art, and indicates by a relevancy indicator (e.g., percentage level) the chance or probability that the art is § 102 art, which might be reduced if not all relevant terms are found in the art reference.

The GUI 600 can show that a document is relevant as § 103 art (art that would anticipate the invention if combined with other art, or art that would render the novel concepts of the invention, or the claims of the invention, obvious). The search and analysis system can be operable to determine that art references in the same field of art (e.g., based on recitations such as “cyber security” or “cable communications”) have one or more elements of the entered and submitted search terms (e.g., claim terms), such that when combined, and in view of each other, or in view of the § 102 art reference(s), would render the concept (or claims) obvious. As with the § 102 art, the search and analysis system can provide an indicator of relevance of the § 103 art (e.g., by percentage). The percentage can be based on, for example, the frequency with which relevant terms appear in the document and/or the order, sequence, or nearness of certain relevant terms with other relevant terms, or whether the documents contains words that teach the combinability of the reference with other references (e.g., “can be integrated with,” “can be modified by,” etc.).

Clicking on the relevance and indicated section can result in the display, for example, of the claim at issue, and the relevant sections of the prior art (e.g., displayed in a section within a GUI), and the relevant legal source of authority (e.g., codes/laws/rules/regulations) sections. The GUI can thus present a preliminary review for patentability that is a level of review that is less than a full review for patentability by a patent examiner that typically reviews the patent application for all patentability requirements.

The example user interface embodiment shown in FIG. 6 also allows for a user to input any remarks for any art reference returned as a result of the patentability search and analysis. For example, the user can select the “Input Remarks” button 610 under the Notes and Remarks column to reveal a field in which remarks can be entered. Such remarks can be useful, for example, to remind the user of, perhaps, differences between the concepts of the submission and the art reference. The search and analysis system can also allow for the removal of the remarks at any time.

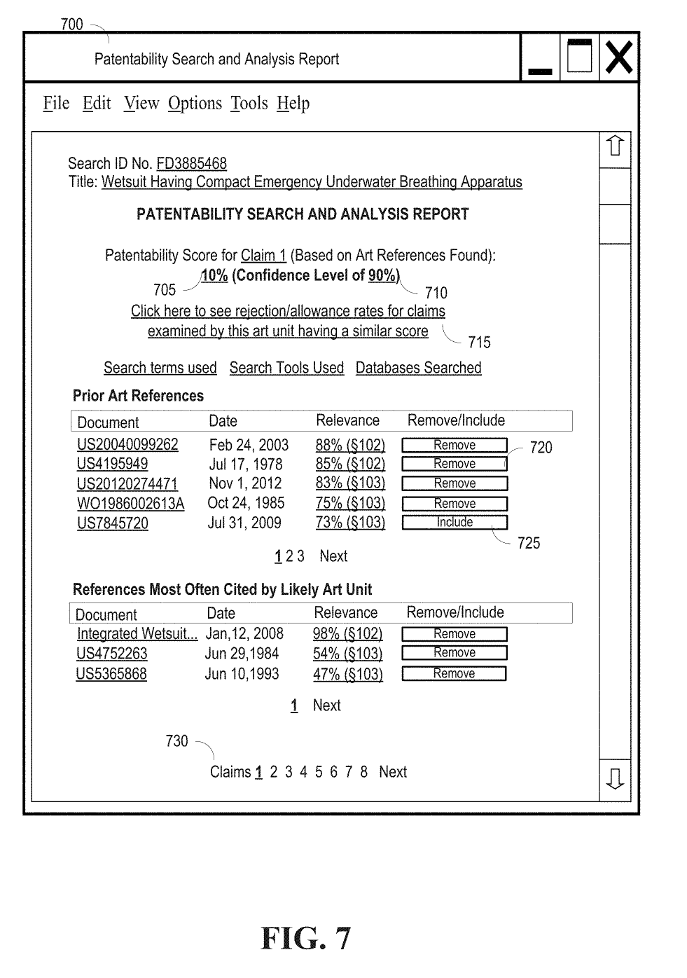

FIG. 7 presents another example of a GUI 700 that can be generated by the search and analysis system of the present application. Here, based on the prior art found, relevancy of the art, the patentability search and analysis system can determine a patentability indicator (e.g., a patentability score) representative of the likelihood that a patent will be granted on a patent application representative of the submission (e.g., assessment of patentability). As shown in the GUI 700, a patentability score 705 is provided by the search and analysis system for claim 1 which in this scenario was submitted (e.g., submitted as input through entry field 415) for search and analysis. If no claim was submitted, the search and analysis system can indicate that the score is for the description of the concept submitted, terms submitted (whether by extraction and determination from a file, or by user entry). The patentability score can be based on, for example, the art found as a result of the search, wherein the patentability score can be inversely related to the relevance and type of prior art found (e.g., the more relevant a reference is indicated to be, and the more § 102 references are found, the lower the patentability score). It can be based on a variety of factors/criteria, for example, whether the art is a § 102 or § 103 reference, the number of references found, the number of § 102 versus § 103 references, the relevance of the references, the dates of the references. Different weights can be assigned to each factor (e.g., a § 102 reference would be more heavily weighted than a § 103 reference), wherein the weights can be at default value, but can be altered (and thus is customizable) by the user, by a software system (e.g., a self-learning software algorithm), or by a service provider.

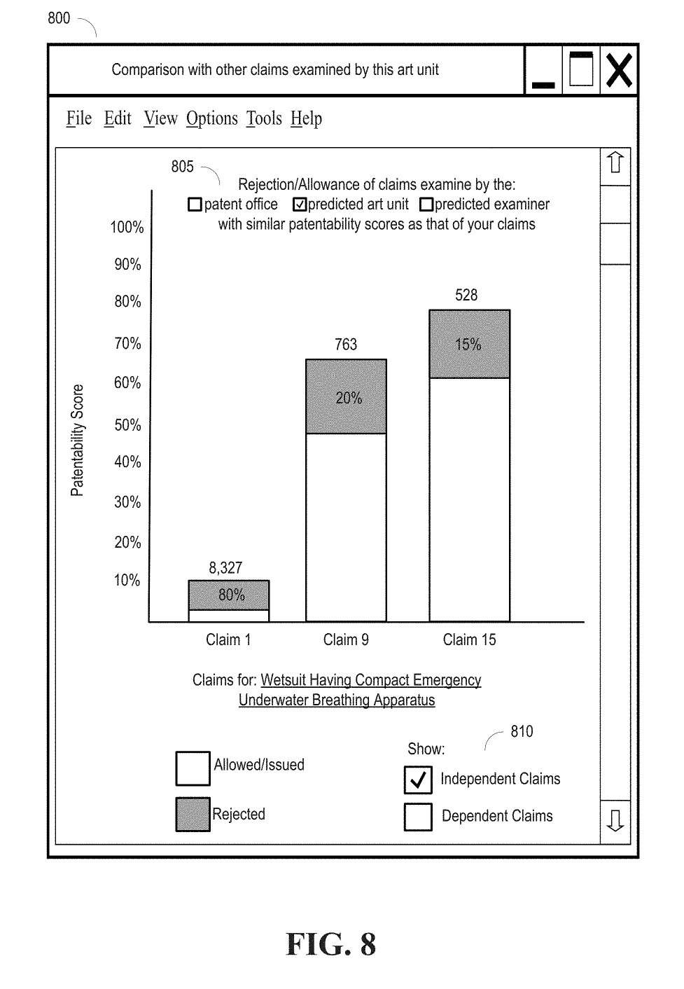

Additionally, the system can provide a “confidence level” (e.g., confidence level 710) representative of the strength of the patentability score as a predictor of patentability, based on a variety of criteria or factors. In addition to considering some of the same factors that goes into the patentability score, the confidence level can be based on the rejection and allowance rates for other patents (e.g., the claims of those applications) having a similar value to the patentability score of the concept (or claims if they were submitted by the user), as well as the total number of those patents that had a similar score (e.g., sample size). In example embodiments, the search and analysis system can present a link (e.g., hyperlink) that can generate another GUI (as shown in FIG. 8) that can present more information regarding rejection and allowance rates for other patents having the same or similar patentability score.

The system is also operable to change the value of the patentability indicator based on, for example, a selection by a user indicating that a particular art found through the search should be removed from consideration. Referring to FIG. 7, the search and analysis system can present a “Remove” button (e.g., Remove button 720), which can be generated to appear in the row associated with an art reference. In response to a user selecting the remove button, the search and analysis system will update the patentability score analyzing the art references sans the art reference removed from consideration. Thus, in response to a user's selection of the remove button 720, the search and analysis system will remove from consideration art reference U.S. Pat. No. 4,195,949 in its analysis and update the patentability score accordingly. If an art reference has been selected by a user for removal, the search and analysis system can also be operable to generate “Include” buttons (e.g., Include button 725) so that a user can command the search and analysis system to add the reference back for consideration.

Section 730 of the GUI 700 provides a mechanism for a user to view the patentability scores for each claim that the user has submitted for search and analysis. In example embodiments, the search and analysis system can generate independent claim numbers in, for example, a different color, size, or font.

Moving on to FIG. 8 now, the search and analysis system can be operative to generate a GUI (e.g., GUI 800) related to information regarding the rejection and allowance of the claims of other patents that have, based on analysis by the search and analysis system. The search and analysis system can be operable to analyze publicly available prosecution file histories (e.g., documents and correspondence submitted by an applicant of a patent application to a patent office, as well as correspondence from a patent office, related to the procurement of a particular patent) of patent applications that have been filed with a patent office. Based on the prosecution history, the search and analysis system can determine whether submitted claims have been rejected or allowed. For example, the search and analysis system can determine that claims have been rejected if an office action following a submission of patent claims (or claim amendments) have a subsequent office action that rejects or objects to the claims that were submitted. If a response to an office action was filed, the search and analysis system can also determine the claims after being amended. It can make this determination, for example, by accounting for any mark-up rules of a patent office (e.g., underline to insert a claim term, bracket or strike-throughs, for example, to take out a claim term. For each claim that has been rejected, the search and analysis system can evaluate that claim by performing a patentability search for that claim, and obtaining a patentability score for that claim. Likewise, for each claim (either original or amended) that has been allowed by a patent office, or issued by a patent office, the search and analysis system can perform a patentability search for that allowed or issued claim to determine a patentability score for the allowed or issued claim. Thus, for a particular set of patents having the same patentability score as determined by the search and analysis system, the search and analysis system can determine whether that claim has been rejected or allowed. The search and analysis system can provide aggregate information in a GUI (e.g., GUI 800) so that a user can compare his concept (or claims) with those that have been previously filed with a particular patent office.

Of note, the file histories of the patents need not be located at a patent office, but can reside in a repository, accessible by the search and analysis system, that contains the file histories of a substantial number of patent applications (for example, all, close to all, or many patent applications) submitted to a patent office.

Referring to FIG. 8, the search and analysis system can enable a user to select (e.g., by checking a box in section 805) to view the statistical rejection/allowance data for patent claims submitted for the patent office as a whole, the predicted art unit, or the predicted examiner (e.g., selectable by the user).

In the example shown in FIG. 8, a bar graph can be generated by the search and analysis system showing, for the independent claims that were submitted by the user (e.g., claim 1, claim 9, and claim 15). For claim 1, claim 9, and claim 15, the bar graph shows the number of patents that had the same or similar patentability score as that of claims 1, 9, and 15. Thus, claim 1 had a patentability score of 10% (as shown in the example GUI 700 of FIG. 7), as indicated in the caption of the Y axis of the bar graph. The first bar of the bar graph shows that 8,327 claims having a patentability score of 10% were submitted, in this example, to the predicted art unit that would review a filed patent application having claim 1 as its claim. Out of the 8,327 claims that scored a 10%, which is the same patentability score that was determined for claim 1, 80 percent of those claims were rejected by the predicted are unit, as indicated by the first bar graph generated by the search and analysis system (e.g., in the grade shading labeled “80%”). If previously filed claims or patents had a score of 10%, the system can use, for example, claims having patentability score with the next closest value as that of the patentability indicator (e.g., perhaps 11%, or 15%). The sample size of 8,327 can be classified as large (e.g., versus perhaps a few dozen claims having the same patentability score), which can in example embodiments play a role in determining the confidence level associated with the patentability score for claim 1. Of note, in GUI 800, section 810, a user can elect to view in the bar graph the independent claims, the depending claims, or both. The search and analysis system can display the relevant bar based on the user's selection (e.g., by checking the appropriate box).

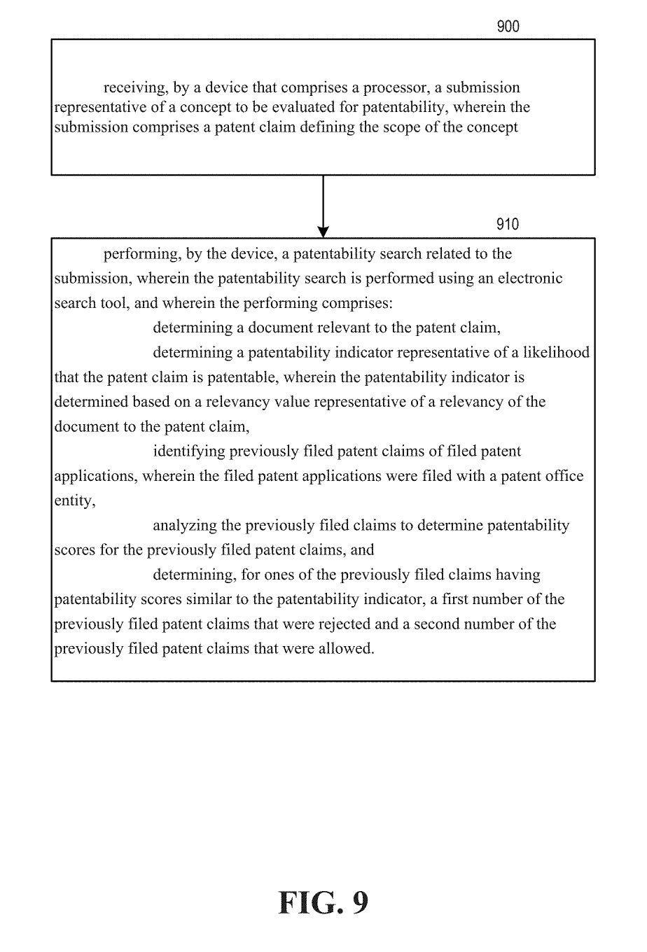

FIGS. 9-11 illustrate example flow diagrams illustrating patentability search and analysis in accordance with various aspects and embodiments of the subject disclosure. A device comprising a processor and a memory that stores executable instructions that, when executed by the processor, can facilitate performance of operations as described in the example flow diagrams.

As shown in FIG. 9, in one non-limiting embodiment, a method can comprise, at 900, receiving, by a device that comprises a processor, a submission representative of a concept to be evaluated for patentability, wherein the submission comprises a patent claim defining the scope of the concept.

At step 910, the method can further comprise performing, by the device, a patentability search related to the submission, wherein the patentability search is performed using an electronic search tool. The electronic search tool can comprise a search engine designated by the patent office entity for electronic patentability searches.

The patentability search can comprise determining a document relevant to the patent claim. The document can be, for example, an art reference (e.g., prior art reference).

The patentability search can further comprise determining a patentability indicator (e.g., patentability score) representative of a likelihood that the patent claim is patentable, wherein the patentability indicator is determined based on a relevancy value representative of a relevancy of the document to the patent claim. The relevancy value can be based on a determination that the document contains terms relevant to the patent claim.

The patentability search can further comprise identifying previously filed patent claims of filed patent applications, wherein the filed patent applications were filed with a patent office entity. The identifying the previously filed patent claims can further comprise determining an art unit of the patent office entity to which a patent application containing the patent claim is likely to be assigned for examination, and wherein the filed patent applications were assigned to the art unit for examination. The identifying the previously filed patent claims can also comprise determining a patent examiner identity to which a patent application containing the patent claim is likely to be assigned for examination, and wherein the filed patent applications were assigned to the patent examiner identity for examination.

The patentability search can also comprise analyzing the previously filed claims to determine patentability scores for the previously filed patent claims.

The patentability search can further comprise determining, for ones of the previously filed claims having patentability scores similar to the patentability indicator, a first number of the previously filed patent claims that were rejected and a second number of the previously filed patent claims that were allowed.

The patentability search can further comprise generating, for display in a graphical user interface, a percentage value representative of the first number and the second number.

The patentability search can further comprise determining a confidence level representative of a strength of the patentability indicator as a predictor of patentability. The confidence level can be determined based on a quantity of the filed patent applications (e.g., sample size).

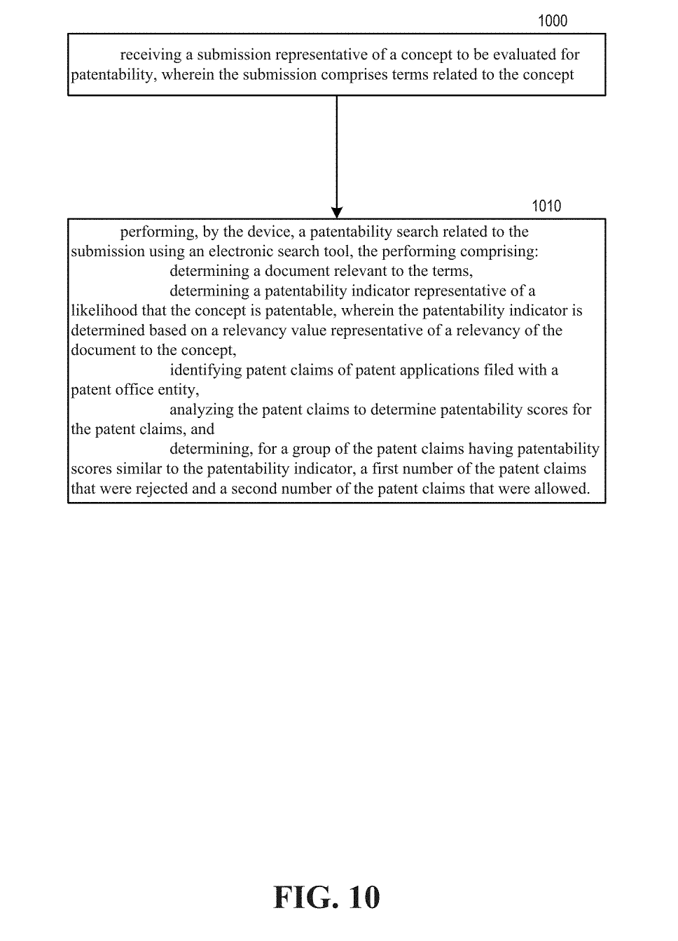

Referring now to FIG. 10, in another non-limiting embodiment, a device is provided comprising a processor and a memory that stores executable instructions that, when executed by the processor, facilitate performance of operations. As shown at 1000, the operations can comprise receiving a submission representative of a concept to be evaluated for patentability, wherein the submission comprises terms related to the concept.

The operations at 1010 further comprise performing, by the device, a patentability search related to the submission using an electronic search tool. The electronic search tool can comprise a search engine designated by the patent office entity for electronic patentability searches.

The patentability search comprises determining a document (e.g., a reference, art reference, prior art reference) relevant to the terms.

The patentability search further comprises determining a patentability indicator (e.g., patentability score) representative of a likelihood that the concept is patentable, wherein the patentability indicator is determined based on a relevancy value representative of a relevancy of the document to the concept. The relevancy value can be based on a determination that the document contains terms relevant to the patent claim. The patentability search can further comprise receiving a command for a removal of the document (e.g., art reference) from consideration in determining the patentability indicator.

The patentability search further comprises identifying patent claims of patent applications filed with a patent office entity. The determining the patent claims can further comprise determining an art unit of the patent office entity to which a patent application embodying the concept is likely to be assigned for examination, and wherein the patent applications were assigned to the art unit for examination. The identifying the patent claims can also comprise determining a patent examiner identity to which a patent application embodying the concept is likely to be assigned for examination, and wherein the patent applications were assigned to the patent examiner identity for examination.

The patentability search further comprises analyzing the patent claims to determine patentability scores for the patent claims

The patentability search further comprises determining, for a group of the patent claims having patentability scores similar to the patentability indicator, a first number of the patent claims that were rejected and a second number of the patent claims that were allowed.

The operations can further comprise generating, for display in a graphical user interface, a rate of allowance reflective of the first number and the second number.

The operations can further comprise determining a confidence level representative of a strength of the patentability indicator as a predictor of patentability. The confidence level can be determined, for example, based on the quantity of the patent applications (e.g., determined based on a sample size).

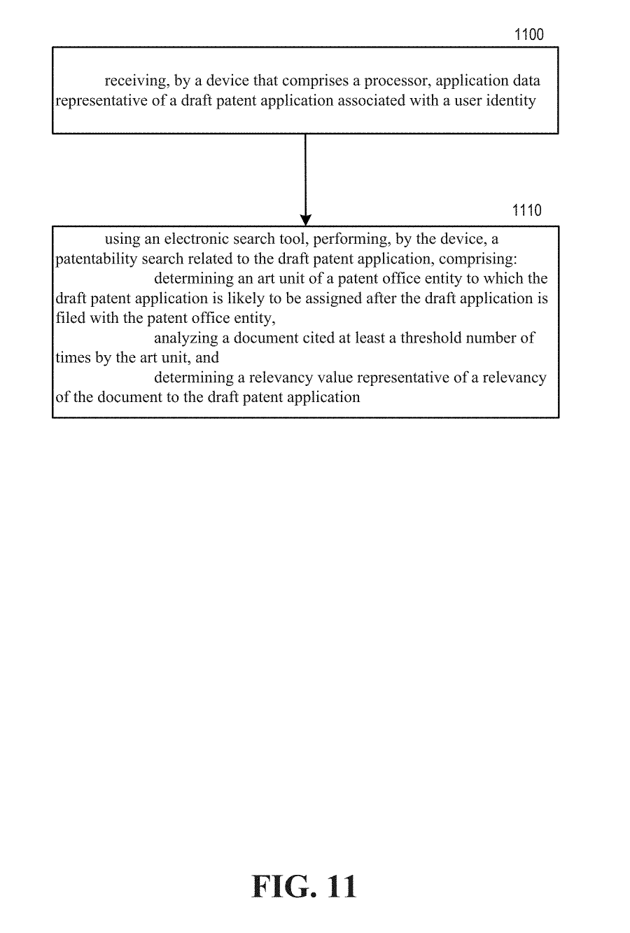

Moving to FIG. 11, in a non-limiting embodiment, a method can comprise, at 1100, receiving, by a device that comprises a processor, application data representative of a patent application associated with a user identity (e.g., inventor, assignee, patent agent, patent attorney, etc.).

At 1110, the method can further comprise using an electronic search tool, performing, by the device, a patentability search related to the draft patent application. The electronic search tool can comprise a search engine designated by the patent office entity for electronic patentability searches.

The patentability search can comprise determining an art unit of a patent office entity to which the patent application is likely to be assigned after the draft application is filed, with the patent office entity (e.g., in the event that the user identity chooses to file the draft patent application with the patent office entity).

The patentability search can further comprise analyzing a document cited at least a threshold number of times by the art unit, and determining a relevancy value representative of a relevancy of the document to the patent application. The document can be a document cited at least the threshold number of times by the art unit. The document can also be a document selected by the user identity. The document can also be a document selected by an examiner identity (e.g., patent examiner) of the patent office entity to which the draft patent application is likely to be assigned for review after the draft patent application is filed with the patent office identity. The document can also be a document selected from an information disclosure statement submitted by the user identity subsequent to the receiving of the application data. The document can also be a document selected from references cited in a prior patent application that is related to the draft patent application.

The patentability search can also comprise analyzing a result of the patentability search and determining a source of patent authority (e.g., patentability rule, regulation, or law, such as 35 U.S.C. § 102, or 35 U.S.C. § 103 in the case of the USPTO) associated with the patent office entity applicable to the result. The result of the patentability search relates to a deficiency associated with the draft patent application (e.g., lack of antecedent basis, informal drawings, etc.).

Referring now to FIG. 12, there is illustrated a block diagram of a computer 1200 operable to execute the functions and operations performed in the described example embodiments. For example, a user device (e.g., UE 140) or servers (e.g., servers 120) can contain components as described in FIG. 12. The computer 1200 can provide networking and communication capabilities between a wired or wireless communication network and a server and/or communication device. In order to provide additional context for various aspects thereof, FIG. 12 and the following discussion are intended to provide a brief, general description of a suitable computing environment in which the various aspects of the innovation can be implemented to facilitate the establishment of a transaction between an entity and a third party. While the description above is in the general context of computer-executable instructions that can run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation can also be practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media or communications media, which two terms are used herein differently from one another as follows.

Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, solid state drives (SSDs), or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

Communications media can embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference to FIG. 12, implementing various aspects described herein with regards to the end-user device can include a computer 1200, the computer 1200 comprising a processing unit 1204, a system memory 1206 and a system bus 1208. The system bus 1208 couples system components comprising the system memory 1206 to the processing unit 1204. The processing unit 1204 can be any of various commercially available processors. Dual microprocessors and other multi-processor architectures can also be employed as the processing unit 1204.

The system bus 1208 can be any of several types of bus structure that can further interconnect to a memory bus (with or without a memory controller), a peripheral bus, and a local bus using any of a variety of commercially available bus architectures. The system memory 1206 comprises read-only memory (ROM) 1227 and random access memory (RAM) 1212. A basic input/output system (BIOS) is stored in a non-volatile memory 1227 such as ROM, EPROM, EEPROM, which BIOS contains the basic routines that help to transfer information between elements within the computer 1200, such as during start-up. The RAM 1212 can also include a high-speed RAM such as static RAM for caching data.

The computer 1200 further comprises an internal hard disk drive (HDD) 1214 (e.g., EIDE, SATA), which internal hard disk drive 1214 can also be configured for external use in a suitable chassis (not shown), a magnetic floppy disk drive (FDD) 1216, (e.g., to read from or write to a removable diskette 1218) and an optical disk drive 1220, (e.g., reading a CD-ROM disk 1222 or, to read from or write to other high capacity optical media such as the DVD). The hard disk drive 1214, magnetic disk drive 1216 and optical disk drive 1220 can be connected to the system bus 1208 by a hard disk drive interface 1224, a magnetic disk drive interface 1226 and an optical drive interface 1228, respectively. The interface 1224 for external drive implementations comprises at least one or both of Universal Serial Bus (USB) and IEEE 1294 interface technologies. Other external drive connection technologies are within contemplation of the subject innovation.

The drives and their associated computer-readable media provide nonvolatile storage of data, data structures, computer-executable instructions, and so forth. For the computer 1200 the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer 1200, such as zip drives, magnetic cassettes, flash memory cards, cartridges, and the like, can also be used in the example operating environment, and further, that any such media can contain computer-executable instructions for performing the methods of the disclosed innovation.

A number of program modules can be stored in the drives and RAM 1212, comprising an operating system 1230, one or more application programs 1232, other program modules 1234 and program data 1236. All or portions of the operating system, applications, modules, and/or data can also be cached in the RAM 1212. It is to be appreciated that the innovation can be implemented with various commercially available operating systems or combinations of operating systems.

A user can enter commands and information into the computer 1200 through one or more wired/wireless input devices, e.g., a keyboard 1238 and a pointing device, such as a mouse 1240. Other input devices (not shown) can include a microphone, an IR remote control, a joystick, a game pad, a stylus pen, touch screen, or the like. These and other input devices are often connected to the processing unit 1204 through an input device interface 1242 that is coupled to the system bus 1208, but can be connected by other interfaces, such as a parallel port, an IEEE 2394 serial port, a game port, a USB port, an IR interface, etc.

A monitor 1244 or other type of display device is also connected to the system bus 1208 through an interface, such as a video adapter 1246. In addition to the monitor 1244, a computer 1200 typically comprises other peripheral output devices (not shown), such as speakers, printers, etc.

The computer 1200 can operate in a networked environment using logical connections by wired and/or wireless communications to one or more remote computers, such as a remote computer(s) 1248. The remote computer(s) 1248 can be a workstation, a server computer, a router, a personal computer, portable computer, microprocessor-based entertainment device, a peer device or other common network node, and typically comprises many or all of the elements described relative to the computer, although, for purposes of brevity, only a memory/storage device 1250 is illustrated. The logical connections depicted include wired/wireless connectivity to a local area network (LAN) 1252 and/or larger networks, e.g., a wide area network (WAN) 1254. Such LAN and WAN networking environments are commonplace in offices and companies, and facilitate enterprise-wide computer networks, such as intranets, all of which can connect to a global communications network, e.g., the Internet.

When used in a LAN networking environment, the computer 1200 is connected to the local network 1252 through a wired and/or wireless communication network interface or adapter 1256. The adapter 1256 can facilitate wired or wireless communication to the LAN 1252, which can also include a wireless access point disposed thereon for communicating with the wireless adapter 1256.

When used in a WAN networking environment, the computer 1200 can include a modem 1258, or is connected to a communications server on the WAN 1254, or has other means for establishing communications over the WAN 1254, such as by way of the Internet. The modem 1258, which can be internal or external and a wired or wireless device, is connected to the system bus 1208 through the input device interface 1242. In a networked environment, program modules depicted relative to the computer, or portions thereof, can be stored in the remote memory/storage device 1250. It will be appreciated that the network connections shown are exemplary and other means of establishing a communications link between the computers can be used.

The computer is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This comprises at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE802.11 (a, b, g, n, etc.) to provide secure, reliable, fast wireless connectivity. A Wi-Fi network can be used to connect computers to each other, to the Internet, and to wired networks (which use IEEE802.3 or Ethernet). Wi-Fi networks operate in the unlicensed 2.4 and 5 GHz radio bands, at an 11 Mbps (802.11b) or 54 Mbps (802.11a) data rate, for example, or with products that contain both bands (dual band), so the networks can provide real-world performance similar to the basic “10BaseT” wired Ethernet networks used in many offices.

Referring now to FIG. 13, illustrated is a schematic block diagram of a user equipment (e.g., UE 102) that can be a mobile device (e.g., mobile handset 1300) capable of connecting to a network in accordance with some embodiments described herein. Although a mobile handset 1300 is illustrated herein, it will be understood that other devices can be a mobile device, and that the mobile handset 1300 is merely illustrated to provide context for the embodiments of the various embodiments described herein. The following discussion is intended to provide a brief, general description of an example of a suitable environment 1300 in which the various embodiments can be implemented. While the description comprises a general context of computer-executable instructions embodied on a machine-readable storage medium, those skilled in the art will recognize that the innovation also can be implemented in combination with other program modules and/or as a combination of hardware and software.

Generally, applications (e.g., program modules) can include routines, programs, components, data structures, etc., that perform particular tasks or implement particular abstract data types. Moreover, those skilled in the art will appreciate that the methods described herein can be practiced with other system configurations, comprising single-processor or multiprocessor systems, minicomputers, mainframe computers, as well as personal computers, hand-held computing devices, microprocessor-based or programmable consumer electronics, and the like, each of which can be operatively coupled to one or more associated devices.

A computing device can typically include a variety of machine-readable media. Machine-readable media can be any available media that can be accessed by the computer and comprises both volatile and non-volatile media, removable and non-removable media. By way of example and not limitation, computer-readable media can comprise computer storage media and communication media. Computer storage media can include volatile and/or non-volatile media, removable and/or non-removable media implemented in any method or technology for storage of information, such as computer-readable instructions, data structures, program modules or other data. Computer storage media can include, but is not limited to, RAM, ROM, EEPROM, flash memory or other memory technology, CD ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and comprises any information delivery media. The term “modulated data signal” means a signal that has one or more of its characteristics set or changed in such a manner as to encode information in the signal. By way of example, and not limitation, communication media comprises wired media such as a wired network or direct-wired connection, and wireless media such as acoustic, RF, infrared and other wireless media. Combinations of the any of the above should also be included within the scope of computer-readable media.

The handset 1300 comprises a processor 1302 for controlling and processing all onboard operations and functions. A memory 1304 interfaces to the processor 1302 for storage of data and one or more applications 1306 (e.g., a video player software, user feedback component software, etc.). Other applications can include voice recognition of predetermined voice commands that facilitate initiation of the user feedback signals. The applications 1306 can be stored in the memory 1304 and/or in a firmware 1308, and executed by the processor 1302 from either or both the memory 1304 or/and the firmware 1308. The firmware 1308 can also store startup code for execution in initializing the handset 1300. A communications component 1310 interfaces to the processor 1302 to facilitate wired/wireless communication with external systems, e.g., cellular networks, VoIP networks, and so on. Here, the communications component 1310 can also include a suitable cellular transceiver 1311 (e.g., a GSM transceiver) and/or an unlicensed transceiver 1313 (e.g., Wi-Fi, WiMax) for corresponding signal communications. The handset 1300 can be a device such as a cellular telephone, a PDA with mobile communications capabilities, and messaging-centric devices. The communications component 1310 also facilitates communications reception from terrestrial radio networks (e.g., broadcast), digital satellite radio networks, and Internet-based radio services networks.

The handset 1300 comprises a display 1312 for displaying text, images, video, telephony functions (e.g., a Caller ID function), setup functions, and for user input. For example, the display 1312 can also be referred to as a “screen” that can accommodate the presentation of multimedia content (e.g., music metadata, messages, wallpaper, graphics, etc.). The display 1312 can also display videos and can facilitate the generation, editing and sharing of video quotes. A serial I/O interface 1314 is provided in communication with the processor 1302 to facilitate wired and/or wireless serial communications (e.g., USB, and/or IEEE 1394) through a hardwire connection, and other serial input devices (e.g., a keyboard, keypad, and mouse). This supports updating and troubleshooting the handset 1300, for example. Audio capabilities are provided with an audio I/O component 1316, which can include a speaker for the output of audio signals related to, for example, indication that the user pressed the proper key or key combination to initiate the user feedback signal. The audio I/O component 1316 also facilitates the input of audio signals through a microphone to record data and/or telephony voice data, and for inputting voice signals for telephone conversations.

The handset 1300 can include a slot interface 1318 for accommodating a SIC (Subscriber Identity Component) in the form factor of a card Subscriber Identity Module (SIM) or universal SIM 1320, and interfacing the SIM card 1320 with the processor 1302. However, it is to be appreciated that the SIM card 1320 can be manufactured into the handset 1300, and updated by downloading data and software.

The handset 1300 can process IP data traffic through the communication component 1310 to accommodate IP traffic from an IP network such as, for example, the Internet, a corporate intranet, a home network, a person area network, etc., through an ISP or broadband cable provider. Thus, VoIP traffic can be utilized by the handset 1300 and IP-based multimedia content can be received in either an encoded or decoded format.

A video processing component 1322 (e.g., a camera) can be provided for decoding encoded multimedia content. The video processing component 1322 can aid in facilitating the generation, editing and sharing of video quotes. The handset 1300 also comprises a power source 1324 in the form of batteries and/or an AC power subsystem, which power source 1324 can interface to an external power system or charging equipment (not shown) by a power I/O component 1326.

The handset 1300 can also include a video component 1330 for processing video content received and, for recording and transmitting video content. For example, the video component 1330 can facilitate the generation, editing and sharing of video quotes. A location tracking component 1332 facilitates geographically locating the handset 1300. As described hereinabove, this can occur when the user initiates the feedback signal automatically or manually. A user input component 1334 facilitates the user initiating the quality feedback signal. The user input component 1334 can also facilitate the generation, editing and sharing of video quotes. The user input component 1334 can include such conventional input device technologies such as a keypad, keyboard, mouse, stylus pen, and/or touch screen, for example.

Referring again to the applications 1306, a hysteresis component 1336 facilitates the analysis and processing of hysteresis data, which is utilized to determine when to associate with the access point. A software trigger component 1338 can be provided that facilitates triggering of the hysteresis component 1338 when the Wi-Fi transceiver 1313 detects the beacon of the access point. A SIP client 1340 enables the handset 1300 to support SIP protocols and register the subscriber with the SIP registrar server. The applications 1306 can also include a client 1342 that provides at least the capability of discovery, play and store of multimedia content, for example, music.

The handset 1300, as indicated above related to the communications component 1310, comprises an indoor network radio transceiver 1313 (e.g., Wi-Fi transceiver). This function supports the indoor radio link, such as IEEE 802.11, for the handset 1300. The handset 1300 can accommodate at least satellite radio services through a handset that can combine wireless voice and digital radio chipsets into a single handheld device.

As used in this application, the terms “system,” “component,” “interface,” and the like, are generally intended to refer to a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. These components also can execute from various computer readable storage media comprising various data structures stored thereon. The components can communicate via local and/or remote processes such as in accordance with a signal comprising one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry that is operated by software or firmware application(s) executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. An interface can comprise input/output (I/O) components as well as associated processor, application, and/or API components.

Furthermore, the disclosed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, computer-readable carrier, or computer-readable media. For example, computer-readable media can include, but are not limited to, a magnetic storage device, e.g., hard disk; floppy disk; magnetic strip(s); an optical disk (e.g., compact disk (CD), a digital video disc (DVD), a Blu-ray Disc™ (BD)); a smart card; a flash memory device (e.g., card, stick, key drive); and/or a virtual device that emulates a storage device and/or any of the above computer-readable media.

As it employed in the subject specification, the term “processor” can refer to substantially any computing processing unit or device comprising single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of UE. A processor also can be implemented as a combination of computing processing units.

In the subject specification, terms such as “store,” “data store,” “data storage,” “database,” “repository,” “queue”, and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory. In addition, memory components or memory elements can be removable or stationary. Moreover, memory can be internal or external to a device or component, or removable or stationary. Memory can comprise various types of media that are readable by a computer, such as hard-disc drives, zip drives, magnetic cassettes, flash memory cards or other types of memory cards, cartridges, or the like.

By way of illustration, and not limitation, nonvolatile memory can comprise read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

In particular and in regard to the various functions performed by the above described components, devices, circuits, systems and the like, the terms (comprising a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated example aspects of the embodiments. In this regard, it will also be recognized that the embodiments comprise a system as well as a computer-readable medium comprising computer-executable instructions for performing the acts and/or events of the various methods.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can comprise, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

On the other hand, communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communications media comprise wired media, such as a wired network or direct-wired connection, and wireless media such as acoustic, RF, infrared and other wireless media.

Further, terms like “user equipment,” “user device,” “mobile device,” “mobile,” “station,” “access terminal,” “terminal,” “handset,” and similar terminology, generally refer to a wireless device utilized by a subscriber or user of a wireless communication network or service to receive or convey data, control, voice, video, sound, gaming, or substantially any data-stream or signaling-stream. The foregoing terms are utilized interchangeably in the subject specification and related drawings. Likewise, the terms “access point,” “node B,” “base station,” “evolved Node B,” “cell,” “cell site,” and the like, can be utilized interchangeably in the subject application, and refer to a wireless network component or appliance that serves and receives data, control, voice, video, sound, gaming, or substantially any data-stream or signaling-stream from a set of subscriber stations. Data and signaling streams can be packetized or frame-based flows. It is noted that in the subject specification and drawings, context or explicit distinction provides differentiation with respect to access points or base stations that serve and receive data from a mobile device in an outdoor environment, and access points or base stations that operate in a confined, primarily indoor environment overlaid in an outdoor coverage area. Data and signaling streams can be packetized or frame-based flows.

Furthermore, the terms “user,” “subscriber,” “customer,” “consumer,” and the like are employed interchangeably throughout the subject specification, unless context warrants particular distinction(s) among the terms. It should be appreciated that such terms can refer to human entities, associated devices, or automated components supported through artificial intelligence (e.g., a capacity to make inference based on complex mathematical formalisms) which can provide simulated vision, sound recognition and so forth. In addition, the terms “wireless network” and “network” are used interchangeable in the subject application, when context wherein the term is utilized warrants distinction for clarity purposes such distinction is made explicit.

Moreover, the word “exemplary,” where used, is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

In addition, while a particular feature may have been disclosed with respect to only one of several implementations, such feature can be combined with one or more other features of the other implementations as may be desired and advantageous for any given or particular application. Furthermore, to the extent that the terms “have”, “having”, “includes” and “including” and variants thereof are used in either the detailed description or the claims, these terms are intended to be inclusive in a manner similar to the term “comprising.”

The above descriptions of various embodiments of the subject disclosure and corresponding figures and what is described in the Abstract, are described herein for illustrative purposes, and are not intended to be exhaustive or to limit the disclosed embodiments to the precise forms disclosed. It is to be understood that one of ordinary skill in the art can recognize that other embodiments comprising modifications, permutations, combinations, and additions can be implemented for performing the same, similar, alternative, or substitute functions of the disclosed subject matter, and are therefore considered within the scope of this disclosure. Therefore, the disclosed subject matter should not be limited to any single embodiment described herein, but rather should be construed in breadth and scope in accordance with the claims below.

What is claimed is:

1. A method, comprising:
receiving, by a device that comprises a processor, a submission representative of a concept to be evaluated for patentability, wherein the submission comprises a patent claim defining the scope of the concept; and
performing, by the device, a patentability search related to the submission, wherein the patentability search is performed using an electronic search tool, and wherein the performing comprises:
determining a document relevant to the patent claim,
determining a patentability indicator representative of a likelihood that the patent claim is patentable, wherein the patentability indicator is determined based on a relevancy value representative of a relevancy of the document to the patent claim,
identifying previously filed patent claims of filed patent applications, wherein the filed patent applications were filed with a patent office entity,
analyzing the previously filed claims to determine patentability scores for the previously filed patent claims, and
determining, for ones of the previously filed claims having patentability scores similar to the patentability indicator, a first number of the previously filed patent claims that were rejected and a second number of the previously filed patent claims that were allowed.

2. The method of claim 1, wherein the patentability search further comprises generating, for display in a graphical user interface, a percentage value representative of the first number and the second number.

3. The method of claim 1, wherein the electronic search tool comprises a search engine designated by the patent office entity for electronic patentability searches.

4. The method of claim 1, wherein the relevancy value is based on a determination that the document contains terms relevant to the patent claim.

5. The method of claim 1, wherein the identifying the previously filed patent claims further comprises determining an art unit of the patent office entity to which a patent application containing the patent claim is likely to be assigned for examination, and wherein the filed patent applications were assigned to the art unit for examination.

6. The method of claim 1, wherein the identifying the previously filed patent claims further comprises determining a patent examiner identity to which a patent application containing the patent claim is likely to be assigned for examination, and wherein the filed patent applications were assigned to the patent examiner identity for examination.

7. The method of claim 1, wherein the patentability search further comprises determining a confidence level representative of a strength of the patentability indicator as a predictor of patentability.

8. The method of claim 7, wherein the confidence level is determined based on a quantity of the filed patent applications.

9. A device, comprising:
a processor; and
a memory that stores executable instructions that, when executed by the processor, facilitate performance of operations, comprising:
receiving a submission representative of a concept to be evaluated for patentability, wherein the submission comprises terms related to the concept; and
performing, by the device, a patentability search related to the submission using an electronic search tool, the performing comprising:
determining a document relevant to the terms,
determining a patentability indicator representative of a likelihood that the concept is patentable, wherein the patentability indicator is determined based on a relevancy value representative of a relevancy of the document to the concept,
identifying patent claims of patent applications filed with a patent office entity,
analyzing the patent claims to determine patentability scores for the patent claims, and
determining, for a group of the patent claims having patentability scores similar to the patentability indicator, a first number of the patent claims that were rejected and a second number of the patent claims that were allowed.

10. The device of claim 9, wherein the operations further comprise generating, for display in a graphical user interface, a rate of allowance reflective of the first number and the second number.

11. The device of claim 9, wherein the electronic search tool comprises a search engine designated by the patent office entity for electronic patentability searches.

12. The device of claim 9, wherein the relevancy value is based on a determination that the document contains terms relevant to the patent claim.

13. The device of claim 9, wherein the operations further comprise receiving a command for a removal of the document from consideration in determining the patentability indicator.

14. The device of claim 9, wherein the operations further comprise determining a confidence level representative of a strength of the patentability indicator as a predictor of patentability.

15. The device of claim 14, wherein the confidence level is determined based on a quantity of the patent applications.

16. The device of claim 9, wherein the identifying the patent claims further comprises determining an art unit of the patent office entity to which a patent application embodying the concept is likely to be assigned for examination, and wherein the patent applications were assigned to the art unit for examination.

17. The device of claim 9, wherein the identifying the patent claims further comprises determining a patent examiner identity to which a patent application embodying the concept is likely to be assigned for examination, and wherein the patent applications were assigned to the patent examiner identity for examination.

18. A method, comprising:
receiving, by a device that comprises a processor, application data representative of a draft patent application associated with a user identity; and
using an electronic search tool, performing, by the device, a patentability search related to the draft patent application, comprising:
determining an art unit of a patent office entity to which the draft patent application is likely to be assigned after the draft application is filed with the patent office entity,
analyzing a document cited at least a threshold number of times by the art unit, and
determining a relevancy value representative of a relevancy of the document to the draft patent application.

19. The method of claim 18, wherein the electronic search tool comprises a search engine designated by the patent office entity for electronic patentability searches.

20. The method of claim 18, wherein the document is a first document cited at least the threshold number of times by the art unit, and wherein the performing the patentability search further comprises:
analyzing a second document selected by the user identity.

21. The method of claim 18, wherein the document is a first document cited at least the threshold number of times by the art unit, and wherein the performing the patentability search further comprises:
analyzing a second document selected by an examiner identity of the patent office entity to which the draft patent application is likely to be assigned for review after the draft patent application is filed with the patent office entity.

22. The method of claim 18, wherein the document is a first document cited at least the threshold number of times by the art unit, and wherein the performing the patentability search comprises:
analyzing a second document selected from an information disclosure statement submitted by the user identity subsequent to the receiving of the application data.

23. The method of claim 18, wherein the document is a first document cited at least the threshold number of times by the art unit, and wherein the performing the patentability search comprises:
analyzing a second document selected from references cited in a prior patent application that is related to the draft patent application.

24. The method of claim 18, wherein the performing the patentability search comprises analyzing a result of the patentability search and determining a source of patent authority associated with the patent office entity applicable to the result.

25. The method of claim 24, wherein the result of the patentability search relates to a deficiency associated with the draft patent application.
